(19) United States
(12) Patent Application Publication
(10) Pub. No.: US 2002/0054431 A1
(43) Pub. Date: May 9, 2002

(54) Single-lens stereoscopic infinity microscope

(76) Inventor: Bryan Costales, Boulder, CO (US)

Correspondence Address: Douglas W. Swartz, SHERIDAN ROSS P.C., Suite 1200, 1560 Broadway, Denver, CO, 80202-5141, US

(21) Appl. No.: 10/002,716

(22) Filed: Nov. 1, 2001

Related U.S. Application Data
(60) Provisional application No. 60/245,793, filed on Nov. 3, 2000.

(51) Int. Cl. G02B 21/22; G02B 27/22; G02B 27/26

(52) U.S. Cl. 359/462; 359/465; 359/376

(57) ABSTRACT

The present invention is directed to various stereoscopic optical apparatuses. In one configuration, the apparatus uses a common optical encoder to interface with a number of different objectives. In one configuration, the apparatus uses an encoder that can be either removed from the optical path or reconfigured to produce a two-dimensional rather than a three-dimensional representation of an object. In one configuration, an optical encoder is provided that can provide filtration based on wavelength alone or based on both polarization and wavelength.

### CROSS REFERENCE TO RELATED APPLICATIONS

The present application claims priority under 35 U.S.C. §119(e) to U.S. Provisional Patent Application Ser. No. 60/245,793, filed Nov. 3, 2000, having the same title, which is incorporated herein by this reference. Cross reference is made to U.S. patent application Ser. No. 09/354,230, filed Jul. 16, 1999; U.S. Provisional Patent Application Ser. No. 60/166,902, filed Nov. 22, 1999; U.S. Provisional Patent Application Ser. No. 60/180,038, filed Feb. 3, 2000, and U.S. patent application Ser. No. 09/664,084 filed Sep. 18, 2000 entitled “SINGLE-LENS STEREOSCOPIC LIGHT-VALVES AND APPARATUSES”, and having Attorney File No. 4446-6-CIP, all of which are incorporated herein by reference.

### FIELD OF THE INVENTION

The present invention is related generally to optical systems and specifically to optical systems for acquiring stereoscopic images.

### BACKGROUND OF THE INVENTION

Stereoscopic imaging is useful in a broad variety of applications and devices, such as microscopes, endoscopes, video devices, photographic devices, to name but a few. Generally, stereoscopic images are produced by dividing light reflected by or transmitted through the object into two parts or images of the object, e.g., left and right eye views. The two parts or images, when viewed by a viewer, will produce a three-dimensional image of the object as each eye will see a different image of the object. The images can be viewed simultaneously as with two oculars, or sequentially, as with video, to provide the three-dimensional image.

In designing a three-dimensional apparatus, there are a number of design considerations. First, in many applications it is desirable to provide for two-dimensional or three-dimensional viewing on demand. Providing separate viewing devices, each of which is dedicated to either two-dimensional or three-dimensional viewing is not only expensive but also inconvenient. Second, in many applications it is desirable to provide the capability of selecting from among a number of differently powered objectives. Users often wish to see a variety of views of an object to determine which view is most desirable. As stated previously, it is desirable to provide such capability in the same optical device. Finally, in many applications users may desire to realize three-dimensional effects using different optical characteristics. For example, using differently colored optical filters to produce optical signals having differing wavelength distributions can provide three-dimensional images that are improperly colored, depending upon the optical filters selected. Likewise using differently oriented polarizing filters to produce optical signals have differing polarization orientations can provide three-dimensional images that suffer from scintillation when viewing reflecting or polarizing objects. Accordingly, the user should have the ability to select the optical characteristic which will form the basis of the three-dimensional image.

### SUMMARY OF THE INVENTION

The present invention is directed to variously configured optical systems for acquiring a three dimensional image of an object. The optical systems and/or components thereof can be employed in a multiplicity of optical devices, such as microscopes, endoscopes, ocular fundus cameras, still cameras, video recorders, motion picture cameras, surveying equipment, and traffic safety equipment.

In a first embodiment, a stereoscopic apparatus is provided that includes without limitation:

(a) a plurality of objectives;

(b) an objective mount movably (e.g., rotatably) connected to or engaged with a body member to permit alignment of a selected objective of the plurality of objectives with an optical path; and

(c) a stereoscopic valve for encoding radiation passing through the selected objective.

When the objective mount is rotated by a user, the stereoscopic valve remains at least substantially stationary. This feature permits the same valve to used with each of the objectives, thereby saving material and manufacturing costs and provides for ease and simplicity of operation.

The objectives typically have differing properties. The objectives can have different working distances, indices of refraction, numerical apertures, and/or focal powers.

The objective mount, nosepiece or turret, is typically disk-shaped. The objectives are mounted, either permanently or removably (e.g., via a threaded interface), at substantially uniform radial and/or circumferential intervals around the mount.

The body member typically has a base member engaging the turret. The base member has a hole that aligns with the selected objective. The hole and selected objective are aligned with the optical path.

In one configuration, the mount and/or base member is located between the objectives and the stereoscopic valve. Typically, the distance between the selected objective and the stereoscopic valve is at least about 10 mm and more typically ranges from about 2 mm to about 40 mm.

The stereoscopic valve can have many different configurations. Typically, the stereoscopic valve is one or more of a color filter (e.g., an anaglyphic filter), a polarizing filter (e.g., a plane or circular polarizing filter), a retarder (e.g., a half-wave, quarter-wave, etc., retarder), a shutter, a rotating polarizer, a polarization rotator (e.g., an FELC or LC), a polarizing beam splitter, a beam splitter that filters based on color, an occluder, a filter that alters the wavefront, and combinations thereof.

In a preferred configuration, the stereoscopic valve has at least two parts. A first part produces first encoded radiation, and a second part produces second encoded radiation. For example, the first and second parts can be polarizing filters having transverse polarization orientations. The first encoded radiation has a different characteristic than the second encoded radiation. The differing characteristic is amplitude, phase, intensity, envelope, and/or frequency.

In a preferred configuration, both the (unencoded) radiation and encoded radiation are each infinitely focused.

The stereoscopic valve can be permanently or removably supported by the body member or another optical component. In one configuration, the stereoscopic valve engages a rear focus conversion lens. In one configuration, the stereoscopic valve is permanently attached to the body member.

In a second embodiment, a method for producing a three dimensional image is provided that may be used with the optical apparatus described above. The method includes without limitation the steps of:

(a) passing first radiation through a first selected objective;

(b) encoding the first radiation with the stereoscopic valve to form first encoded radiation, the first encoded radiation having a first encoded first portion and a first encoded second portion, the first encoded first portion having a different characteristic than the first encoded second portion;

(c) moving the first selected objective out of alignment with the stereoscopic valve;

(d) moving a second selected objective into alignment with the stereoscopic valve;

(e) passing second radiation through the second selected objective; and

(e) encoding the second radiation with the stereoscopic valve to form second encoded radiation, the second encoded radiation having a second encoded first portion and a second encoded second portion, the second encoded first portion having a different characteristic than the second encoded second portion.

In yet another embodiment, a method for operating an optical apparatus is provided that includes without limitation the steps of:

(a) focusing first radiation reflected by an object to be imaged to form focused first radiation;

(b) encoding the focused first radiation with two or more polarizing filters to form encoded first radiation, wherein the encoded first radiation has at least first and second encoded first portions, the first and second encoded first portions having a different characteristic;

(c) processing the first and second encoded first portions to form a three-dimensional image of the object;

(d) rotating at least one of the two or more encoded portions into at least substantial mutual alignment to convert the apparatus from producing a three-dimensional image to producing a two-dimensional image;

(e) focusing second radiation reflected by the object to be imaged to form focused second radiation;

(f) encoding the focused second radiation with the two or more polarizing filters to form encoded second radiation, wherein any two portions of the encoded second radiation have at least substantially the same polarization; and

(g) processing the encoded second radiation to form a two-dimensional image of the object.

The method permits the optical apparatus to produce not only three-dimensional but also two-dimensional images at the discretion of the user. This capability is highly useful in many applications.

In yet another embodiment, an optical encoder is provided that includes at least:

(a) a substrate having opposing first and second surfaces;

(b) at least one color filter located on the first surface; and

(c) at least one polarizing filter located on the second surface.

The optical encoder permits filtration to be performed in differing ways. For example, the encoder can include two color filters (e.g., red and cyan filters, blue and yellow, amber and yellow, and pink and light green) and two polarizing filters (e.g., plane polarizing filters). The polarizing filters can be moved into substantial alignment in which case any two segments of the encoded radiation will have the same polarization characteristics while first and second segments of the encoded radiation will have differing wavelength distributions or bands. Alternatively, the polarizing filters can be moved out of alignment in which case first and second segments of the encoded radiation will have not only differing wavelength distributions but also differing polarization orientations.

In yet another embodiment, an optical apparatus is provided that utilizes the encoder. The apparatus includes:

(a) a lens for focusing radiation reflected by an object;

(b) an optical encoder, including:

(i) at least one color filter; and

(ii) at least one polarizing filter; and

(c) first and second analyzing filters, each of the first and second analyzing filters including at least one color filter and at least one polarizing filter.

The lens, optical encoder and first analyzing filter form a first optical path, and the lens, optical encoder, and second analyzing filter form a second optical path that is different from the first optical path.

To facilitate operating the apparatus in the dual modes set forth above, the apparatus can include:

(a) an optical encoder switch for switching between the color filter and the polarizing filter in the optical encoder; and/or

(b) a first analyzing filter switch for switching between the color filter and the polarizing filter in the first analyzing filter; and/or

(c) a second analyzing filter switch for switching between the color filter and the polarizing filter in the second analyzing filter.

The method of operation of the apparatus includes the following steps in a first operational mode:

(a) rotating a first plane polarizing filter in an optical encoder to be at least substantially aligned with a second plane polarizing filter in the optical encoder, the optical encoder further including a first color filter and a second color filter, each passing a different wavelength band of radiation;

(b) rotating a plane polarizing filter of at least one analyzing filter such that the analyzing filter(s) has a polarization orientation that is at least substantially aligned with the first and second plane polarizing filters in the optical encoder; and

(c) thereafter passing radiation through the encoding filter and the first and second analyzing filters to form first and second radiation portions having differing wavelength bands for producing a three-dimensional image of an object. In this mode, the first and second analyzing filters and the first and second plane polarizing filters in the encoder have at least substantially the same polarization orientations.

In a second operational mode, the method can include the further steps of:

(d) rotating the first plane polarizing filter in the optical encoder out of alignment with the second plane polarizing filter in the optical encoder such that the polarization orientations of the filters are transversely oriented;

(e) rotating the plane polarizing filter of the analyzing filter(s) such that the analyzing filter has a polarization orientation that is in at least substantial alignment with one of the first and second plane polarizing filters in the optical encoder; and

(f) thereafter passing radiation through the encoding filter and the first and second analyzing filters to form third and fourth radiation portions having differing polarization orientations and wavelength bands for producing a three-dimensional image of an object.

In this mode, the first analyzing filter and first plane polarizing filter in the encoder have at least substantially the same polarization orientations, and the second analyzing filter and the second plane polarizing filter in the encoder have at least substantially the same polarization orientations.

In yet another embodiment, a method for operating an optical apparatus is provided that includes the steps of:

(a) focusing first radiation reflected by an object to be imaged to form focused first radiation;

(b) encoding the focused first radiation with two or more polarizing filters to form encoded first radiation, wherein the encoded first radiation has at least first and second encoded first portions, the first and second encoded first portions having a different characteristic;

(c) processing the first and second encoded first portions to form a three-dimensional image of the object;

(d) rotating at least one of the two or more polarizing filters to convert the apparatus from producing a three-dimensional image to producing a two-dimensional image;

(e) focusing second radiation reflected by the object to be imaged to form focused second radiation;

(f) encoding the focused second radiation with the two or more polarizing filters to form encoded second radiation, the encoded second radiation has at least first and second encoded second portions, the first and second encoded second portions having a different characteristic; and

(g) processing the encoded second radiation to form a two-dimensional image of the object, wherein at least one of the following statements is true: (i) the first encoded first portion is radially offset from the first encoded second portion and (ii) the second encoded first portion is radially offset from the second encoded second portion.

This embodiment is yet another method to disable 3D in favor of 2D.

The foregoing summary is intended neither to be complete nor exhaustive. As will be appreciated, the various features of the present invention can be combined or used to form a number of other embodiments and configurations which are deemed to be a part of the present invention.

### BRIEF DESCRIPTION OF THE DRAWINGS

FIG. 1 shows diagrammatically how a finite microscope works.

FIG. 2 shows diagrammatically how an infinite focus microscope works.

FIG. 3 shows a simple 3D infinity microscope.

FIG. 4 shows diagrammatically that top illumination will also work.

FIG. 5 shows the preferred placement for the image signal encoder inside the microscope body.

FIG. 6 shows a top view of FIG. 5.

FIG. 7 shows a cut-away view of the microscope body along cut line 29 of FIG. 6 to detail placement of the image signal encoder.

FIG. 8 shows that image encoding filters can contain different basic optical components.

FIG. 9 shows a mechanism for rotating the image signal encoding filter.

FIG. 10 shows FIG. 3 with the encoder rotated.

FIG. 11 shows the encoder orientation required for 3D.

FIG. 12 shows the encoder orientated to prevent 3D.

FIGS. 13 and 14 show a two piece encoder and the rotation.

### DETAILED DESCRIPTION OF THE INVENTION

A simple 3D microscope can be constructed by imposing filters at the appropriate positions into its light path. One approach to such placement is useful for “finite” objective microscopes, while another approach is useful for “infinite” objective microscopes. In this patent we restrict ourselves to the description of infinite objective microscopes.

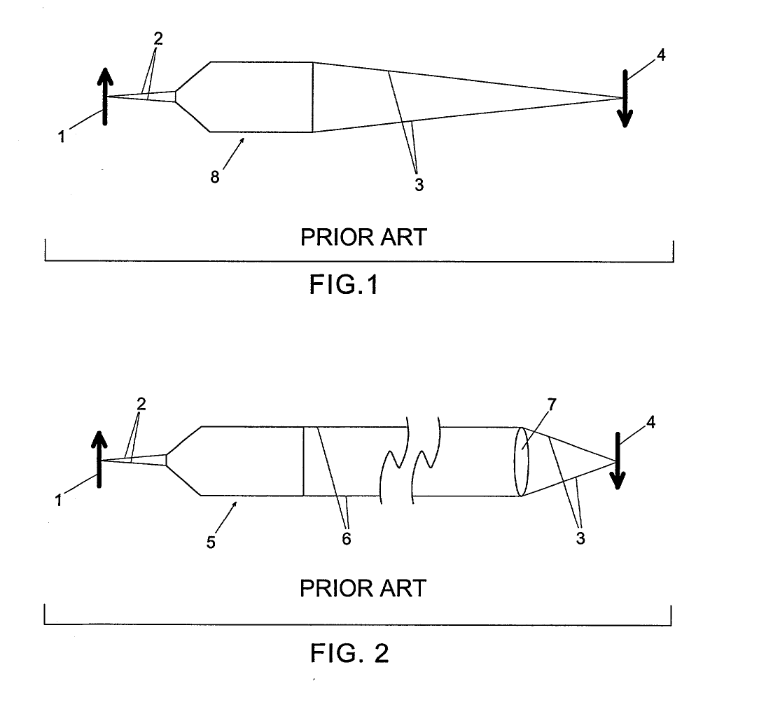

FIG. 1 shows in a simplified diagram how a “finite” objective microscope works. In such a microscope, the object at the object plane 1 is imaged, as indicated by the lines 2, by the finite objective 8. The finite objective is called “finite” because it focuses the gathered image, as indicated by lines 3, onto an image plane 4 that is finitely distant (typically 160 mm).

FIG. 2 shows in a simplified diagram how an “infinite” objective microscope works. In such a microscope, the object at the object plane 1 is imaged, as indicated by lines 2, by the infinite objective 5. The infinite objective is called “infinite” because it focuses the gather image, as indicated by lines 6, onto a theoretical image plane (not shown because it would be off the page) that is infinitely distant. In such microscope systems, there is generally, at a finite distance, a rear focus conversion lens 7 that gathers the infinitely focused image 6 and focuses, as indicated by lines 3, that image onto an image plane 4.

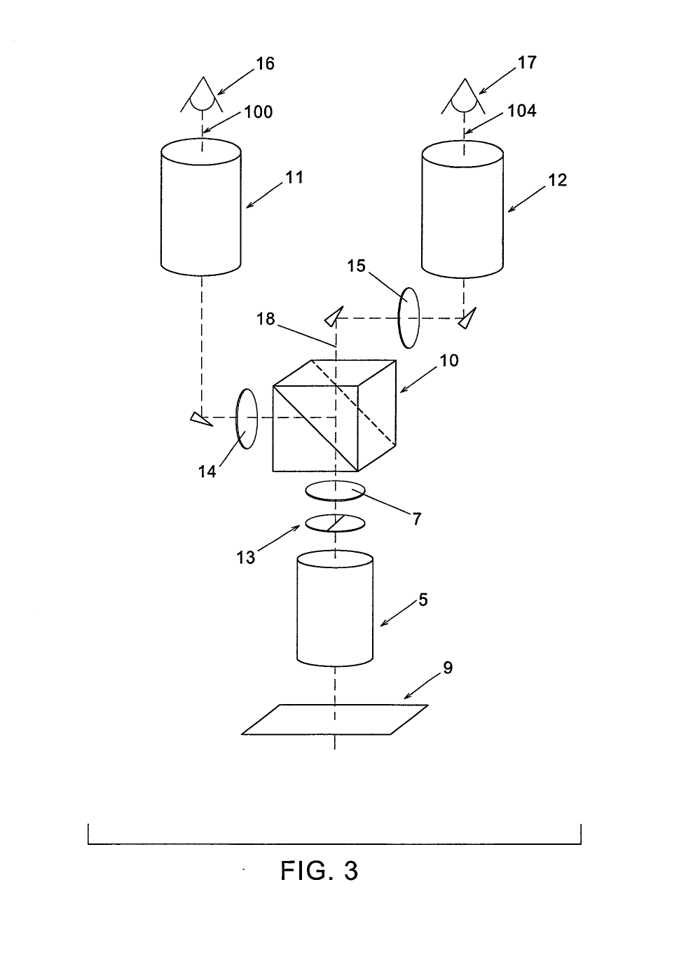

An infinite objective 3D microscope is shown diagrammatically in FIG. 3. A condenser (not shown) gathers illumination from a light source (not shown) and focuses that light onto a object held upon the stage indicated by 9. An infinite focus objective indicated by 5 gathers the image of the object and projects it upward towards a rear focus conversion lens 7 that is generally in the head or eyepiece tube of the microscope. A beam splitter 10 splits the infinitely focused image signal, sending one half of the light to the left ocular 11 and the other half of the light to the other ocular 12, thus providing for a binocular view of the magnified object to the eyes 16 and 17. In such instruments, the image viewed is perceived in 2D.

A 3D microscope is created from a 2D microscope by interposing one or more additional filters into the ordinary light path of an infinite objective microscope. An image signal encoding filter 13 is interposed between the objective 5 and the rear focus conversion lens 7. The image signal encoding filter 13 will generally divide the light path into two parts, one to the left and one to the right of the line 18 that is perpendicular to the plane of the oculars 11 and 12.

Two analyzing filters 14 and 15 are interposed anywhere in the light path between the beam splitter 10 and the human eyes 16 and 17. The analyzing filters are place so as to differentiate the image signal transmitted through the left light path from that transmitted through the right light path. The preferred position is in the microscope head, between the beam splitter 10 and the oculars 11 and 12.

That we show the image signal encoding filter 13 in the preferred position as separate from the head components (7 and above 7 in FIG. 3) and as separate from the objective 5, is not to be taken as limiting. Clearly the two halves of the image signal encoding filter can be laminated or attached to the rear focus conversion lens 7 or to the housing holding that lens. Likewise, the image signal encoding filter can be in close proximity to, but not attached to or adjacent to the objective 5, nor installed inside the objective 5.

That we show the analyzing filters 14 and 15 as separate from the beam splitter 10 is not to be taken as limiting. Clearly, as in the case of plane polarization, a polarizing beam splitter can be use to both split the light energy and to simultaneously provide both analyzing filter roles. Beam splitters also exist that can simultaneously filter on color. Any such beam splitter that also filters the image signal can be used with, and will become a part of this invention.

That we show the image signal encoding filter 13 with its two halves sharing a position in the light path is not to be taken as limiting. Clearly one half can occupy one position in the light stream and the other half can occupy another position in the light path. When the two halves are separate in the light path, they will still be considered a part of this invention.

When interocular separation is set by sliding the oculars apart in a plane, the image signal encoder 13 and the analyzing filters 14 and 15 are preferred to be plane polarizers. When the interocular separation is set by rotating the oculars around an axis, the image signal encoder 13 and the analyzing filters 14 and 15 are preferred to be circular polarizers. Colored filters may be used without regard to the rotation of oculars. Shutters may be used without regard to the rotation of oculars.

That we show the objective 5 above the stage 9 is not to be taken as limiting, because some microscopes are manufactured upside down, or inverted, so that live specimens can be conveniently viewed. Clearly this invention can be used in any such inverted microscopes, and any such implementation shall remain a part of this invention.

That we speak of the image signal encoding filter 13 as having two halves is not to be taken as limiting. Clearly three or more parts can be of value. Four parts, can for example, help create head motion parallax. Three parts can, for example, when the central part is clear, help increase vertical resolution.

That we illustrate the division between the parts of the image signal encoding filter 13 as a linear division is not to be taken as limiting. Clearly that separation or division can be in any of a wide variety of shapes, an “S” curve, for example, or a zig zag. Any shape of division or separation can be used with this invention and its implementation shall still remain a part of this invention.

That we illustrate image signal encoding parts with polarization is not to be taken as limiting. Clearly any form or mechanism of differentiation can be used with this invention and will still produce an acceptable 3D effect. Colored filters, for example, can be of preferred use when a trinocular head is used to take photographs. Or shutters, for example, can be of use when coupling this microscope to a video camera. A half-wave retarder ahead of a plane polarizer can be used when an incorrect polarization effect from two polarizers needs to be corrected. Any such use of other encoding device can be used with this invention and will be considered apart of it.

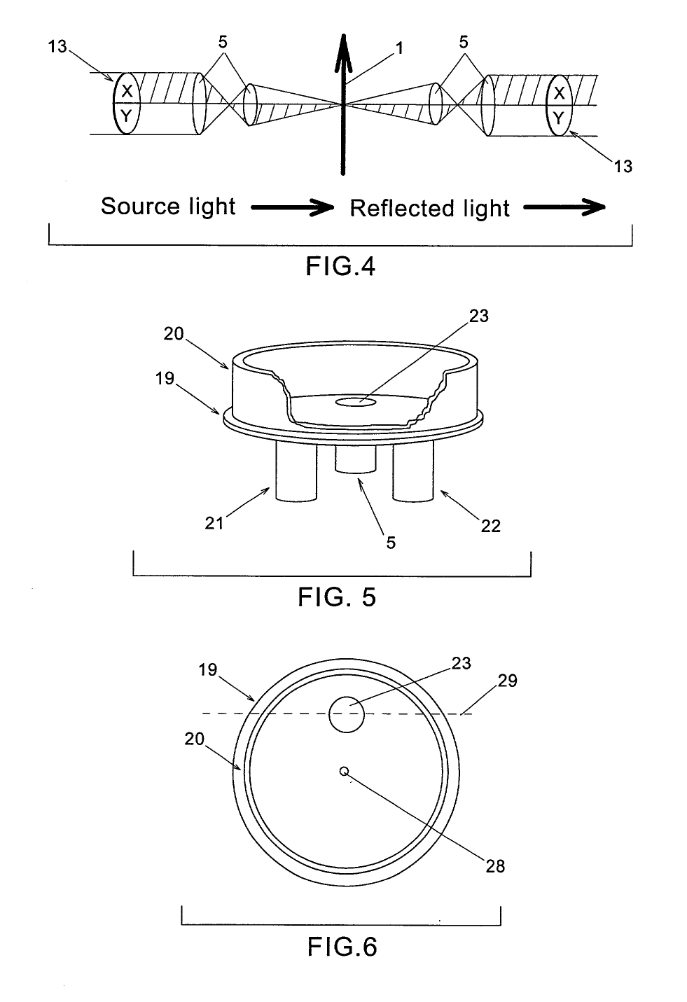

That we show a transmitted light microscope is not to be taken as limiting. Some microscopes light from above. Examples of such microscopes are epi-flourescent and industrial microscopes. FIG. 4 shows that the light passing through such system will also work properly. Observe that the top light source first enters the system from the left of the illustration. It passes through the image signal encoder 13, which causes one half the light to take on property X and the other half to take on property Y. The encoded light then passes through the components that constitute an infinity objective 5, which focuses the light onto the object 1. Light reflected off the object 1 is gathered by the infinity objective 5 which focus the image at infinity. The image signal encoder 13 then filters the light a second time. This time the light contains an image which is encoded with X and Y again. The reflection at 1 does not invert the relationship between source filter 13 and imaging filter 13. If it did, the filter would block its reflected signal which would cause the system to fail.

That we show the effect of top lighting should not be taken as limiting. Clearly light can be introduced into an imaging microscope at any point along its visual axis. Light can be independently shined onto the stage 9 (FIG. 3). Light can likewise be introduced with prisms or mirrors between the image encoding filter 13 and the objective 5. In fact, light can be introduced anywhere into this system and it will still produce a good 3D effect.

That we speak of inexpensive components should not be taken as limiting. It is well known that lenses, in actual practice, are composed of compound lenses that are achromatic with spherical aberration corrections to produce a sharp and clear image. This depiction as inexpensive components is not intended, however, to be limiting because it is well known that more complex lens systems will produce a superior image. Any quality of lens system may nevertheless be employed in this invention and those skilled in the optic arts will be readily be able to employ lens systems of any desired quality.

FIG. 5 shows diagrammatically the main components that compose a microscope turret. A microscope turret is any of a number of means of rotation that allow multiple objectives to be used one at a time in a convenient manner. The turret 19 is generally fitted to the microscope body, a part of which is indicated by 20, with mechanics that allow it to rotate (not shown). Rotation allows each objective lens to stop in turn under a hole 23 up through which the image is projected. For example, the objective 5 is currently shown as under the hole 23 and is thusly the objective in use. The other two objectives, 21 and 22, are in positions to rotate into next use. Objective 22 will rotate into use if the turret is rotated to the right, and objective 23 will rotate into use if the turret is rotated to the left.

FIG. 5 also shows the preferred position for placement of the image signal encoding filter 13. For best optical result, and to allow use of multiple objectives, the image signal encoding filter 13 should preferably be placed into or upon the hole 23 in the microscope body. This position brings the image signal encoder alignment with the rear of each objective, while allowing the turret to rotate. When the image signal encoder is mounted in, or upon, the hole in the microscope body, it is prevented from rotating with the turret, thusly causing it to retain its proper alignment.

That we specify the hole in the body should not be taken as limiting because microscopes can be constructed in a wide variety of manners, both with and without holes. The key point here is to mount the image signal encoder such that it will be aligned with any objective when that objective is in use. Any method or mechanism that allows the image signal encoding filter to be held in the correct position during use shall still be considered a part of this patent.

That we specify for the image signal encoding filter to be held in alignment is also not intended to be limiting. Clearly it can be of benefit for the filter to move into and out of alignment. By allowing it to move out of alignment, a 3D microscope can temporarily be converted back to a 2D microscope. This can be accomplished using three different methods. One method is to remove the image signal encoding filter from the optical path, either by sliding it out of the optical path, or by rotating or pivoting it out of the optical path. A second method is to rotate the filter itself around its plane by about 90 degrees, thereby making the former vertical division into a horizontal division. A third method is to rotate the filter 90 degrees around its vertical, horizontal, or other non-plane axis, but this method is not recommended because it will reduce the resolution of the system. In this method, the plane of the filter can be at least substantially parallel to the optical path. Clearly, when disabling the 3D is desirable, any means of attachment that allows insertion and removal, or change of orientation, shall still be a part of this invention.

By allowing the image encoding filter to invert or rotate about its plane approximately 180 degrees a perceived inversion of 3D can be produced. Clearly, when such an effect is desirable, any means of attachment that allows inversion shall still be a part of this invention.

That we specify the insertion of analyzing filter in the head should be aligned or of a color or material to produce a 3D effect should not be limiting. Clearly by allowing the two filters to be aligned with each other or to be of identical colors or materials, a 3D microscope can be converted back to a 2D microscope. When such a mechanism is desirable, its insertion or design into the head or eyepiece tube shall be a part of this patent. When the analyzing filters are linear polarizers, they may be rotated to align with each other, then when the image signal encoding filter is removed and a sub-stage polarizer is inserted, a standard 2D polarizing microscope is created. When the analyzing filters are linear polarizers, one may be rotated to match the other, thereby disabling 3D.

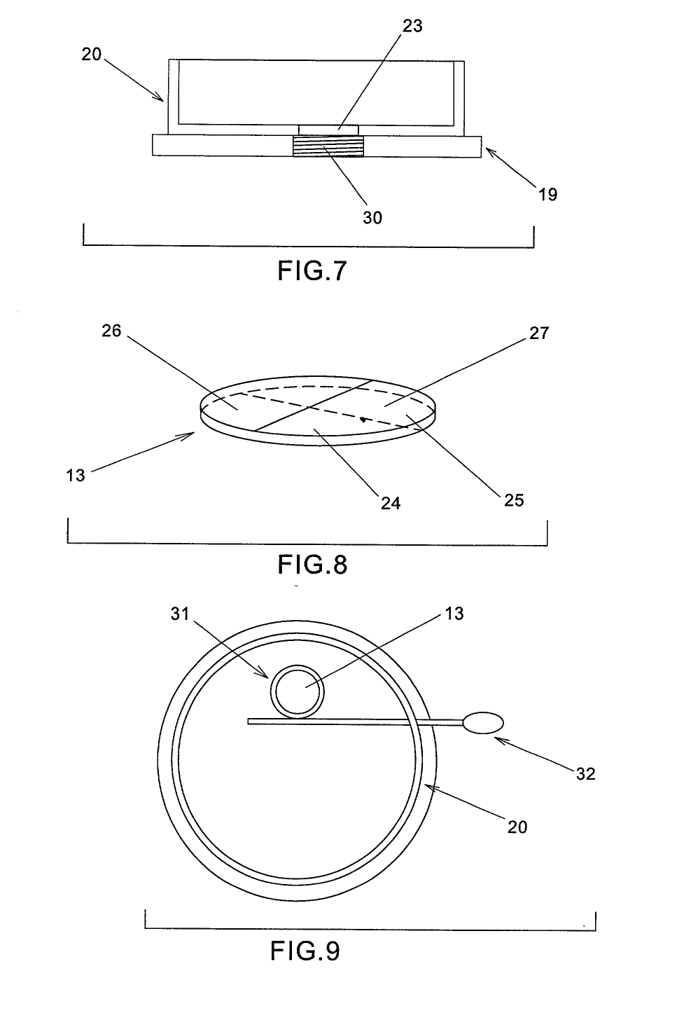

FIG. 6 shows a top view of FIG. 5. The hole 23 in the microscope body 20 is offset from the center of rotation 28 for the turret 19. Line 29 indicates the cut that was used to produce FIG. 7.

FIG. 7 shows a cross-sectional view of the microscope body 20 and the turret 19. A threaded hole is cut into the turret at 30 so that a microscope objective can be fastened at that point. When the lens is aligned for use, it aligns under the hole in the body 23. The image signal encoding filter will fit into or upon that hole.

That we specify matching materials should not be limiting. Clearly combinations of materials will also produce a 3D effect. As shown in FIG. 8, an image signal encoding filter 13 is composed of colored halves 24 and 25 on the bottom, and plane polarizers 26 and 27 on the top. The four components in this image encoding filter match similar filters in the head, plane polarizer analyzing filters for the corresponding plane polarizing filters in the image encoding filter, and colored filters in the head for corresponding colored filters in the image signal encoding filter. A mechanism 28 allows the analyzing filters in the head to switch on demand between polarizing and colored filters.

FIG. 9 shows the image signal encoding filter 13 held in a mechanical sleeve 31. That sleeve is free to rotate. An arm mechanism 32 in the microscope body 20 allows the image signal encoding filter to rotate approximately 90 degrees enabling colored filter 3D to replace polarization based 3D on demand. Such a mechanism can also be used with a single sided filter to turn off and on 3D.

That we show a rotating mechanism is not to be taken as limiting. Clearly other mechanisms or forms of mechanisms can be used to rotate, pivot, slide, or otherwise effect the position or orientation of the image signal encoding filter. Those skilled in the mechanical arts will be able to devise methods of altering the position or orientation of the image encoding filter using many methods not hereby disclosed, yet any such other methods shall still be a part of this invention.

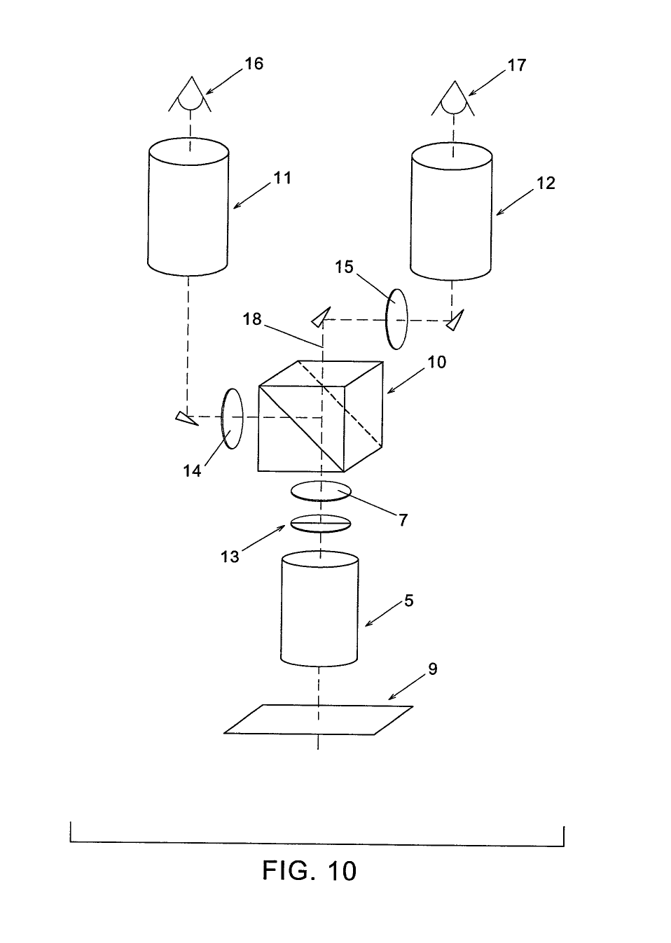

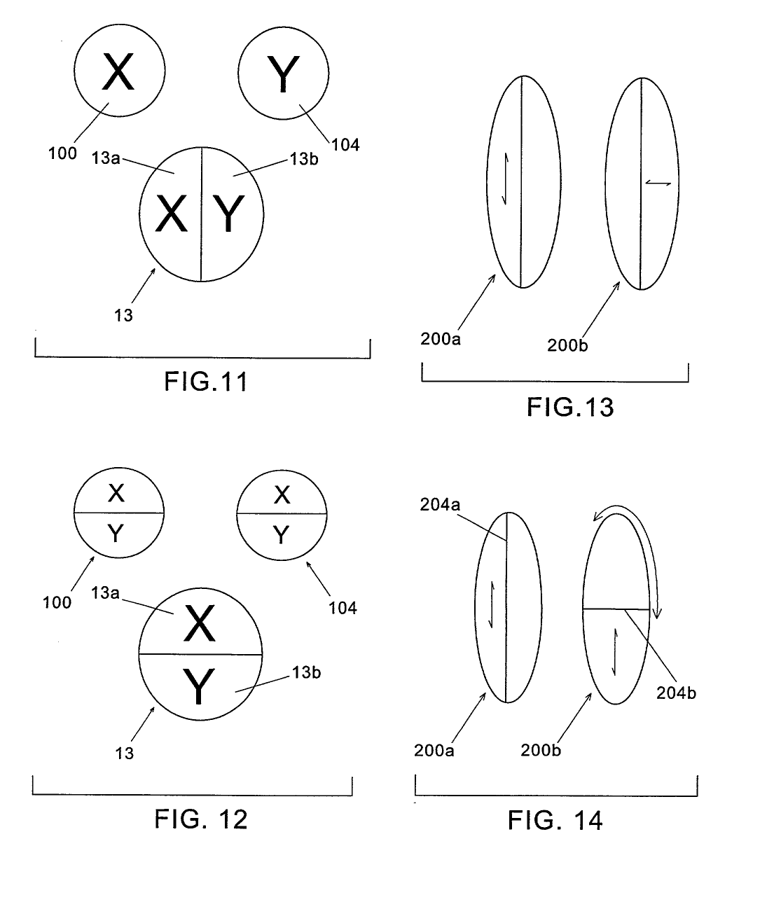

FIGS. 3 and 10 depict the two operational modes of an optical device according to this embodiment. In FIG. 3, the filter 13 is depicted as having a first orientation in which the line between adjacent polarizing filters 13a,b (having transverse and typically at least substantially orthogonal polarization orientations) is normal to the plane of the page. FIG. 11 shows the filter 13 and adjacent polarizing filters 13a,b in the device configuration of FIG. 3. The eyepieces exit light paths 100, 104 of oculars 11, 12 each contain differently encoded radiation. Typically, at least most, and more typically at least about 50%, of the radiation directed to ocular 11 is encoded by polarizing filter 13a (or has the same polarization orientation as filter 13a), and typically at least most, and more typically at least about 50%, of the radiation directed to ocular 12 is encoded by polarizing filter 13b (or has the same polarization orientation as filter 13b). In this embodiment, the eyes perceive a three-dimensional image.

Referring now to FIGS. 10 and 12, the filter 13 is depicted in FIG. 10 as having a second orientation in which the line between adjacent polarizing filters 13a,b (having transverse and typically at least substantially orthogonal polarization orientations) is in the plane of the page. As noted, the filter 13 of FIG. 10 has been rotated clockwise or counterclockwise relative to the filter 13 of FIG. 3. Typically, the angle of rotation ranges from about 45 to about 135 degrees. FIG. 12 shows the filter 13 and adjacent polarizing filters 13a,b in the device configuration of FIG. 10. The eyepieces exiting light paths 100, 104 of oculars 11, 12 each contain differently encoded radiation. Typically, at least about 50%, of the radiation directed to ocular 11 is encoded by polarizing filter 13a (or has the same polarization orientation as filter 13a), and typically at least about 50% of the radiation directed to ocular 12 is encoded by polarizing filter 13b (or has the same polarization orientation as filter 13b). In this embodiment, the eyes perceive a two-dimensional image.

As will be appreciated, “X” and “Y” can refer to optical characteristics other than polarization (for example, frequency, wavelength, phase, and the like). For example “X” and “Y” can refer to at least substantially complementary wavelength filters, such as those combinations described above.

FIGS. 13 and 14 depict another embodiment of the present invention for disabling 3D imaging to produce 2D imaging. In FIG. 13, the adjacent polarizing filters 200a,b (which typically have substantially orthogonal polarization orientations) cover only a portion of the optical path to form separate, differently encoded radiation segments. The other half of each filter typically does not encode the light passing through the equally filter. For example, the other filter half is typically equally transmissive of light of many frequencies and phases. Stated another way, the light exiting each of the transmissive halves of the filters typically has at least substantially the same optical characteristics. In this configuration, the viewer perceives a 3D effect. In one configuration, the segments follow separate optical paths downstream of the filters 200a,b. An analyzing filter having the same polarization orientation as the segment contacting the analyzing filter is located in each of the divergent optical paths. Referring to FIG. 14, filter 200b has been rotated, either clockwise or counterclockwise, such that the edge 204b of the filter 200b is no longer parallel to (but is now transverse to) the edge 204a of the filter 200a and the filters 200a,b have substantially parallel polarization orientations. The angle of rotation is typically around 90 degrees. In this configuration, the viewer perceives a 2D effect. One of the analyzing filters is typically rotated to have the same polarization orientation as the filters 200a,b.

The foregoing description of the present invention has been presented for purposes of illustration and description. Furthermore, the description is not intended to limit the invention to the form disclosed herein. Consequently, variations and modifications commensurate with the above teachings, in the skill or knowledge of the relevant art, are within the scope of the present invention. The embodiments described here and above are further intended to explain best modes for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

What is claimed is:

1. A stereoscopic apparatus, comprising:
a plurality of objectives;
an objective mount movably engaged with a body member to permit alignment of a selected objective of the plurality of objectives with an optical path; and
a stereoscopic valve for encoding radiation passing through the selected objective, wherein, when the objective mount is moved by a user, the stereoscopic valve remains at least substantially stationary.

2. The stereoscopic apparatus of claim 1, wherein the objective mount is located between the plurality of objectives and the stereoscopic valve.

3. The stereoscopic apparatus of claim 1, wherein the distance between the selected objective and the stereoscopic valve is at least about 10 mm.

4. The stereoscopic apparatus of claim 1, wherein the stereoscopic valve is one or more of a color filter, a polarizing filter, a retarder, a shutter, a rotating polarizer, a polarization rotator, a polarizing beam splitter, a beam splitter that filters based on color, an occluder. a filter that alters the wavefront, and combinations thereof.

5. The stereoscopic apparatus of claim 1, wherein the stereoscopic valve engages a rear focus conversion lens.

6. The stereoscopic apparatus of claim 1, wherein the stereoscopic valve is removably attached to the body member.

7. The stereoscopic apparatus of claim 1, wherein the stereoscopic valve has at least two parts, a first part producing first encoded radiation and a second part producing second encoded radiation, the first encoded radiation having a different characteristic than the second encoded radiation.

8. The stereoscopic apparatus of claim 7, wherein the characteristic is at least one of amplitude, phase, intensity, envelope, and frequency.

9. The stereoscopic apparatus of claim 1, wherein the radiation is encoded before contacting an object to be imaged.

10. The stereoscopic apparatus of claim 1, wherein the radiation and encoded radiation are each infinitely focused.

11. The stereoscopic apparatus of claim 1, wherein the stereoscopic valve can be moved into and out of alignment with the selected objective.

12. The stereoscopic apparatus of claim 1, wherein stereoscopic valve is two or more polarizing filters and the polarizing filters can be rotated into mutual alignment to convert the apparatus from producing a three-dimensional image in a stereoscopic mode to producing a two-dimensional image in a nonstereoscopic mode.

13. A method for producing a three dimensional image, comprising:
(a) passing first radiation through a first selected objective;
(b) encoding the first radiation with a stereoscopic valve to form first encoded radiation, the first encoded radiation having a first encoded first portion and a first encoded second portion, the first encoded first portion having a different characteristic than the first encoded second portion;
(c) moving the first selected objective out of alignment with the stereoscopic valve;
(d) moving a second selected objective into alignment with the stereoscopic valve;
(e) passing second radiation through the second selected objective; and
(f) encoding the second radiation with the stereoscopic valve to form second encoded radiation, the second encoded radiation having a second encoded first portion and a second encoded second portion, the second encoded first portion having a different characteristic than the second encoded second portion.

14. A method according to claim 13, wherein the different characteristic in step (b) is the same as the different characteristic in step (e).

15. A method according to claim 13, wherein the stereoscopic valve is one or more of a color filter, a polarizing filter, a retarder, a shutter, a rotating polarizer, a polarization rotator, a polarizing beam splitter, a beam splitter that filters based on color, an occluder, a filter that alters the wavefront, and combinations thereof.

16. The method according to claim 13, wherein the characteristic is at least one of amplitude, phase, intensity, envelope, and frequency.

17. The method according to claim 13, wherein the first and second radiation are encoded before contacting an object to be imaged.

18. The method according to claim 13, wherein the first and second radiation and first and second encoded radiation are each infinitely focused.

19. The method according to claim 13, further comprising:
moving the stereoscopic valve can be moved out of alignment with at least one of the first and second selected objectives.

20. The method according to claim 13, wherein the stereoscopic valve is two or more polarizing filters and further comprising:
aligning a polarization orientation of the polarizing filters to produce a two-dimensional image.

21. A stereoscopic apparatus, comprising:
a plurality of objectives;
an objective mount movably connected to a body member to permit alignment of a selected objective of the plurality of objectives with an optical path; and
a stereoscopic valve for encoding radiation passing through the selected objective, wherein the objective mount is positioned between the selected objective and the stereoscopic valve.

22. The stereoscopic apparatus of claim 21, wherein at least a portion of the body member is located between the plurality of objectives and the stereoscopic valve.

23. The stereoscopic apparatus of claim 21, wherein the distance between the selected objective and the stereoscopic valve is at least about 0.5 inches.

24. The stereoscopic apparatus of claim 21, wherein the stereoscopic valve is one or more of a color filter, a polarizing filter, a retarder, a shutter, a rotating polarizer, a polarization rotator, a polarizing beam splitter, a beam splitter that filters based on color, a filter than alters the wavefront, and combinations thereof.

25. The stereoscopic apparatus of claim 21, wherein the stereoscopic valve engages a rear focus conversion lens.

26. The stereoscopic apparatus of claim 21, wherein the stereoscopic valve is permanently attached to the body member.

27. The stereoscopic apparatus of claim 21, wherein the stereoscopic valve has at least two parts, a first part producing first encoded radiation and a second part producing second encoded radiation, the first encoded radiation having a different characteristic than the second encoded radiation.

28. The stereoscopic apparatus of claim 27, wherein the characteristic is at least one of amplitude, phase, envelope, and frequency.

29. The stereoscopic apparatus of claim 21, wherein the radiation is encoded before contacting an object to be imaged.

30. The stereoscopic apparatus of claim 21, wherein the radiation and encoded radiation are each infinitely focused.

31. The stereoscopic apparatus of claim 21, wherein the stereoscopic valve can be moved into and out of alignment with the selected objective.

32. The stereoscopic apparatus of claim 21, wherein stereoscopic valve is two or more polarizing filters and the polarizing filters can be rotated into mutual alignment to convert the apparatus from producing a three-dimensional image in a stereoscopic mode to producing a two-dimensional image in a nonstereoscopic mode.

33. A stereoscopic apparatus, comprising:
a plurality of objective means for focusing radiation reflected by an object to be imaged;
an objective mounting means for supporting the plurality of objective means, the objective mounting means being movably connected to a body member to permit alignment of a selected objective means of the plurality of objective means with an optical path; and
a stereoscopic encoding means for encoding radiation passing through the selected objective means, wherein the objective mounting means is positioned between the selected objective means and the stereoscopic encoding means.

34. The stereoscopic apparatus of claim 33, wherein the objective mounting means is located between the plurality of objective means and the encoding means.

35. The stereoscopic apparatus of claim 33, wherein the distance between the selected objective means and the encoding means is at least about 0.5 inches.

36. The stereoscopic apparatus of claim 33, wherein the encoding means is one or more of a color filter, a polarizing filter, a retarder, a shutter, a rotating polarizer, a polarization rotator, a polarizing beam splitter, a beam splitter that filters based on color, an occluder, a filter that alters the wavefront, and combinations thereof.

37. The stereoscopic apparatus of claim 33, wherein the encoding means engages a rear focus conversion lens.

38. The stereoscopic apparatus of claim 33, wherein the encoding means is permanently attached to the body member.

39. The stereoscopic apparatus of claim 33, wherein the encoding means has at least two parts, a first part producing first encoded radiation and a second part producing second encoded radiation, the first encoded radiation having a different characteristic than the second encoded radiation.

40. The stereoscopic apparatus of claim 39, wherein the characteristic is at least one of amplitude, phase, intensity, envelope, and frequency and the first and second encoded radiation have different monochromatic spectral components.

41. The stereoscopic apparatus of claim 33, wherein the radiation is encoded before contacting an object to be imaged.

42. The stereoscopic apparatus of claim 33, wherein the radiation and encoded radiation are each infinitely focused.

43. The stereoscopic apparatus of claim 33, wherein the encoding means can be moved into and out of alignment with the selected objective means.

44. The stereoscopic apparatus of claim 33, wherein encoding means is two or more polarizing filters and the polarizing filters can be rotated into mutual alignment to convert the apparatus from producing a three-dimensional image to producing a two-dimensional image.

45. A method for operating an optical apparatus, comprising:
(a) focusing first radiation reflected by an object to be imaged to form focused first radiation;
(b) encoding the focused first radiation with two or more polarizing filters to form encoded first radiation, wherein the encoded first radiation has at least first and second encoded first portions, the first and second encoded first portions having a different characteristic;
(c) processing the first and second encoded first portions to form a three-dimensional image of the object;
(d) rotating at least one of the two or more polarizing filters into mutual alignment to convert the apparatus from producing a three-dimensional image to producing a two-dimensional image;
(e) focusing second radiation reflected by the object to be imaged to form focused second radiation;
(f) encoding the focused second radiation with the two or more polarizing filters to form encoded second radiation, wherein any two portions of the encoded second radiation have at least substantially the same polarization orientation; and
(g) processing the encoded second radiation to form a two-dimensional image of the object.

46. The method according to claim 45, further comprising:
(h) moving a first selected objective out of alignment with the two or more polarizing filters;
(i) moving a second selected objective into alignment with the two or more polarizing filters;
(j) passing third radiation through the second selected objective; and
(k) encoding the third radiation with the two or more polarizing filters to form third encoded radiation, the third encoded radiation having a first encoded third portion and a second encoded third portion, the first encoded third portion having a different characteristic than the second encoded third portion.

47. A method according to claim 46, wherein the different characteristic in step (b) is the same as the different characteristic in step (k).

48. The method according to claim 45, wherein the characteristic is at least one of amplitude, phase, intensity, envelope, and frequency.

49. The method according to claim 45, wherein the first and second radiation are encoded before contacting an object to be imaged.

50. The method according to claim 45, wherein the first and second radiation and first and second encoded radiation are each infinitely focused.

51. The method according to claim 45, further comprising:
moving the stereoscopic two or more polarizing filters out of alignment with at least one of the first and second selected objectives.

52. A stereoscopic apparatus, comprising:
an objective;
a body member supporting the objective; and
two or more polarizing filters, the objective and filters defining an optical path, wherein in a first operational mode the two or more polarizing filters have transversely oriented polarization orientations to form first encoded radiation, two portions of which have differing polarization orientations and in a second operation mode the two or more polarizing filters have at least substantially parallel polarization orientations to form second encoded radiation, any two portions of the second encoded radiation having the same polarization orientation.

53. The stereoscopic apparatus of claim 52, further comprising:
a plurality of objectives; and
an objective mount movably connected to the body member to permit alignment of a selected objective of the plurality of objectives with the optical path, wherein, when the objective mount is moved by a user, the two or more polarizing filters remain at least substantially stationary relative to the optical path.

54. The stereoscopic apparatus of claim 53, wherein the objective mount is located between the plurality of objectives and the stereoscopic valve.

55. The stereoscopic apparatus of claim 53, wherein the distance between the selected objective and the stereoscopic valve is at least about 10 mm.

56. A method for operating an optical apparatus, comprising:
(a) focusing first radiation reflected by an object to be imaged to form focused first radiation;
(b) encoding the focused first radiation with two or more polarizing filters to form encoded first radiation, wherein the encoded first radiation has at least first and second encoded first portions, the first and second encoded first portions having a different characteristic;
(c) processing the first and second encoded first portions to form a three-dimensional image of the object;
(d) rotating at least one of the two or more polarizing filters to convert the apparatus from producing a three-dimensional image to producing a two-dimensional image;
(e) focusing second radiation reflected by the object to be imaged to form focused second radiation;
(f) encoding the focused second radiation with the two or more polarizing filters to form encoded second radiation, the encoded second radiation has at least first and second encoded second portions, the first and second encoded second portions having a different characteristic; and
(g) processing the encoded second radiation to form a two-dimensional image of the object, wherein at least one of the following statements is true: (i) the first encoded first portion is radially offset from the first encoded second portion and (ii) the second encoded first portion is radially offset from the second encoded second portion.

57. The method according to claim 56, further comprising:
(h) diverting at least most of the first encoded first radiation portion along a first optical path and at least most of the second encoded second radiation portion along a second optical path that is different from the first optical path.

58. A method according to claim 57, further comprising:
(i) diverting first part of the second encoded radiation along the first optical path and a second part of the second encoded radiation along the second optical path, wherein the first part of the second encoded radiation includes a substantial amount of each of the first and second encoded second portions and the second part also includes a substantial amount of each of the first and second encoded second portions.

59. The method according to claim 56, further comprising:
diverting a first and second parts of each of the first and second encoded radiation to separate oculars, the first part of the first encoded radiation including at least about 75% of the first encoded first portion and no more than about 25% of the second encoded first portion and the first part of the second encoded radiation including from about 25 to about 75% of the first encoded second portion and from about 25 to about 75% of the second encoded second portion.

60. The method according to claim 56, wherein the first and second radiation are encoded before contacting an object to be imaged.

61. The method according to claim 56, wherein the first and second radiation and first and second encoded radiation are each infinitely focused.

62. A stereoscopic apparatus, comprising:
an objective;
a body member supporting the objective; and
first and second polarizing filters, the objective and filters defining an optical path, wherein in a first operational mode the first and second polarizing filters respectively have first and second polarization orientations to form first encoded radiation, and in a second operation mode the first and second polarizing filters respectively have third and fourth polarization orientations to form second encoded radiation and wherein the first and third polarization orientations of the first polarizing filter are transverse to one another.

63. The stereoscopic apparatus of claim 62, further comprising:
a plurality of objectives; and
an objective mount movably connected to the body member to permit alignment of a selected objective of the plurality of objectives with the optical path, wherein, when the objective mount is moved by a user, the two or more polarizing filters remain at least substantially stationary relative to the optical path.

64. The stereoscopic apparatus of claim 63, wherein the objective mount is located between the plurality of objectives and the stereoscopic valve.

65. The stereoscopic apparatus of claim 63, wherein the distance between the selected objective and the stereoscopic valve is at least about 10 mm.

66. The stereoscopic apparatus of claim 63, wherein the second and fourth polarizing orientations of the second polarizing filter are transverse to one another.

67. An optical encoder, comprising:
a substrate having opposing first and second surfaces;
at least one color filter located on the first surface; and
at least one polarizing filter located on the second surface.

68. The optical encoder of claim 67, wherein the at least one polarizing filter is a pair of transversely oriented plane or circular polarizing filters.

69. The optical encoder of claim 67, wherein the at least one color filter is a pair of first and second color filters, the first color filter having a first color and the second color filter having a second color, wherein the first and second colors are different.

70. An optical apparatus, comprising:
a lens for focusing radiation reflected by an object;
an optical encoder, including:
at least one color filter; and
at least one polarizing filter; and
first and second analyzing filters, each of the first and second analyzing filters including at least one color filter and at least one polarizing filter, wherein the lens, optical encoder and first analyzing filter form a first optical path and the lens, optical encoder, and second analyzing filter form a second optical path that is different from the first optical path.

71. The optical apparatus of claim 70, further comprising at least two of the following:
an optical encoder switch for switching between the at least one color filter and the at least one polarizing filter in the optical encoder;
a first analyzing filter switch for switching between the at least one color filter and the at least one polarizing filter in the first analyzing filter; and
a second analyzing filter switch for switching between the at least one color filter and the at least one polarizing filter in the second analyzing filter.

72. A method for operating an optical apparatus, comprising:
(a) rotating a first plane polarizing filter in an optical encoder to be at least substantially aligned with a second plane polarizing filter in the optical encoder, the optical encoder further including a first color filter and a second color filter, each passing a different wavelength band of radiation;
(b) rotating a plane polarizing filter of at least one analyzing filter such that the at least one analyzing filter has a polarization orientation that is at least substantially aligned with the first and second plane polarizing filters in the optical encoder; and
(c) thereafter passing radiation through the encoding filter and the first and second analyzing filters to form first and second radiation portions having differing wavelength bands for producing a three-dimensional image of an object.

73. The method of claim 72, further comprising after step (d):
(d) rotating the first plane polarizing filter in the optical encoder out of alignment with the second plane polarizing filter in the optical encoder;
(e) rotating the plane polarizing filter of the at least one analyzing filter such that the at least one analyzing filter has a polarization orientation that is in at least substantial alignment with one of the first and second plane polarizing filters in the optical encoder; and
(f) thereafter passing radiation through the encoding filter and the first and second analyzing filters to form third and fourth radiation portions having differing polarization orientations and wavelength bands for producing a three-dimensional image of an object.
